(19) United States
(12) Patent Application Publication
(10) Pub. No.: US 2004/0208566 A1
(43) Pub. Date: Oct. 21, 2004

(54) Coarse WDM system of large capacity with un-cooled lasers

(76) Inventor: Jin Yu, Aliso Viejo, CA (US)

Correspondence Address: Jin Yu, Apt. 103, 23511 Aliso Creek Rd., Aliso Viejo, CA, 92656, US

(21) Appl. No.: 10/041,064

(22) Filed: Jan. 9, 2002

(51) Int. Cl. H04J 14/02

(52) U.S. Cl. 398/79

(57) ABSTRACT

A Coarse Wavelength Division Multiplex (CWDM) system comprises a plurality of transmission channels to send data from transmitter site to remote receiver over a single trunk fiber. The lasers of all channels are un-cooled in transmitter site. The wavelength plan associated with the de-multiplexing filter pass-band of each channel in receiver site tolerates the wavelength variation of 5 nm when the temperature changes from 0 to 50° C. degree. The de-/multiplexing device has two stages. The first stage has a plurality element, each to de-/multiplex between multiple individual channels and a small band of wavelength. The second stage de-/multiplexes between multiple small bands and the entire large band. A plurality of semiconductor optical amplifiers is placed between the two stages of the de-/multiplexing component to compensate optical loss to all optical channels over optical fiber and other optical components.

### BACKGROUND OF THE INVENTION

The present invention relates to the building-up of optical networks, and more particularly to provide connectivity among many telecommunication terminal facilities over a single optical fiber. With the exponentially growing traffic on the Internet, driven by new services and more broadband access subscription, optical networking turns out to be the most promising solution. Dense Wavelength Division Multiplex (DWDM) has been proven very successful in the transmission for long haul backbone of networks for carriers. In metropolitan networks, DWDM products have been just deployed. Low cost is required for such deployment. For DWDM system, small adjacent channel spacing is always required to make large transmission bandwidth. For example, currently most popular system is of 32 channels in 100 GHz channel spacing between two adjacent channels. This system utilizes the amplification bandwidth of 30 nm in C-band of EDFA. Because only 30-nm bandwidth can be used in C-band DWDM system, the requirement of wavelength accuracy and stability of lasers is very stringent to tolerate ambient temperature change. A temperature control loop is always added to laser component for wavelength quality in accuracy and stability. This adds significant cost to system. On the other hand, low-cost un-cooled semiconductor laser has been widely used in optical transmission system. For example, 4-channel so-called Coarse WDM (CWDM) in C-band has been commercialized for several years. The problem of a current CWDM system is its limited transmission capacity without proper optical amplification. Without optical amplification, transmission distance is less than 100 km due to optical loss of fiber. A CWDM channel takes about 6 nm spacing to tolerate temperature change from 0 to 50° C. If a C-band EDFA is used, it covers about 30 nm for optical amplification. With this amount of bandwidth, only about 4 channels can be run for long distance (>100 km). This invention increase the transmission capacity for CWDM operation to have the operation channel count as big as 60 with transmission distance longer than 100 km.

### SUMMARY OF THE INVENTION

In accordance with the present invention, a CWDM system of large capacity comprises channels of wavelength from 1300 to 1700 nm. All the lasers facing to WDM output trunk fiber are un-cooled semiconductor DFB device with direct modulation. The wavelength variation of each laser is about 5 nm when ambient temperature changes from 0 to 50° C. degree. The space of two adjacent channels is 6 nm, leading to maximum channel count greater than 60. There are two stages for channel multiplexing, from multiple local channels to a single output port. The first stage collects multiple channels in a small band as multiple input ports and has an output port including all the channels in this small band. On the individual channel side, the pass-band is greater than 5 nm to tolerate wavelength variation over 5 nm as ambient temperature changes over 50° C. degree. The second stage of the aggregation works similarly to the first stage but for the transformation from multiple small bands to the entire large band. De-multiplexing device is the device to extract each individual channel from the coming entire large band. It has the same construct but inverse traveling direction as the multiplexing device. Note that the aggregation/de-multiplex function is achieved with low cost filters, which require less accuracy and stability in central wavelength and pass bandwidth than DWDM filters need. There is a semiconductor optical amplifier (SOA) on each path of a small band between the two stages to compensate the optical loss for all channels over optical fiber and other optical components. Utilization of SOA is of great importance because of its broad bandwidth and its availability of band from 1300 to 1700 nm.

### BRIEF DESCRIPTION OF THE ITEM

The figure is a schematic representation of a CWDM system in two directions, sending (a) and receiving (b).

### DETAILED DESCRIPTION OF THE INVENTION

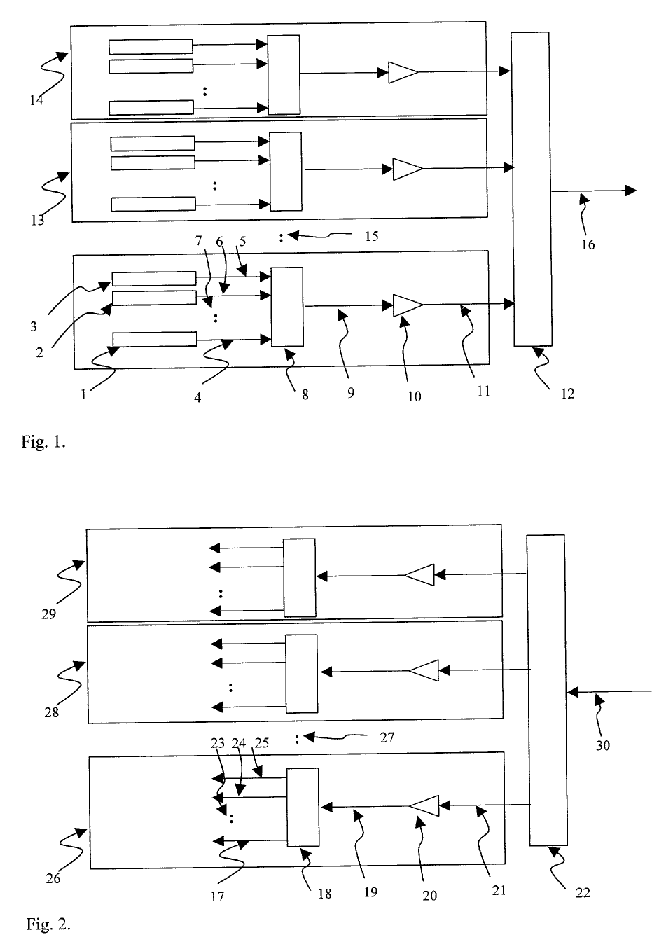

The present invention provides an alternative to currently DWDM system for metropolitan optical networking. Instead of dense WDM, coarse WDM of large capacity is presented to reduce cost. FIGS. 1 and 2 represent the schematic of the invented CWDM system of large capacity. In the transmission direction, the entire band is grouped into several small bands. In the first small band, each laser (item 1, 2, 3, 7) has unique wavelength. The lasers serve to carry data and are linked over fiber jumper (item 4, 5, 6) to the first stage of multiplexing component (item 8). The small band of channels is connected over fiber jumper (item 9) to a semiconductor laser amplifier (item 10) with bandwidth in this small band. The output is connected over fiber jumper (item 11) to one input port of the second stage of multiplexing component (item 12). All other small bands (item 13, 14, 15) are built up similarly to the first small band and connected to the second stage of the multiplexing component. All the channels are finally transmitted to remote node over trunk output port (item 16). In the receiving direction, multiple optical channels are received through receiving trunk port (item 30). The second stage (item 22) of de-multiplexing device separates all channels into several small groups (item 26, 27, 28, 29) of channels. In a small band of channel de-multiplexing, the channels are connected over a fiber jumper (item 21) to a semiconductor laser amplifier (item 20) to compensate optical loss over trunk fiber link from remote node. Then the signal is to the first stage of de-multiplexing component (item 18) over fiber jumper (item 19). The first stage of de-multiplexing component extracts each channel (item 17, 23, 24, 25) from all others. Note that the multiplexing component is identical to the de-multiplexing one but the light traveling directions are inverse. Wavelength covers from 1300 to 1700 nm.

Considering channel spacing of 6 nm, as many as 65 channels can be accommodated in a single fiber using CWDM. Different from DWDM system, no temperature controlling is needed for laser devices to have accurate and stable wavelength for each channel. Wavelength may change over 5 nm when ambient temperature changes from 0 to 50° C. degree. The filter of the first stage of the de-/multiplexing component is of flat bandwidth more than 5 nm to tolerate the wavelength drift due to temperature change. Semiconductor laser amplifier is made from the laser of F-P type. The two end facets are anti-reflection coated to suppress lasing and allow traveling light wave amplification. There is one semiconductor laser amplifier in each path of the small bands. The band and bandwidth of each semiconductor laser amplifier are optimized to match the small band it covers.

I claim:

1. An optical CWDM system of large capacity, see FIG. 1, 2 comprises:
A plurality of optical transmitters to send data from local terminal to remote site;
A plurality of optical receiving port from remote sites;
Trunk output port linked to remote node of network;
Trunk input port linked from remote node of network;
Multiplexing device to combine multiple local optical channels into the trunk output port;
De-multiplex device to extract each channel in trunk input port to its channel port;

2. There is a semiconductor DFB laser in each transmitter in claim 1. The laser serves as carrier for data transmission.

3. In claim 2, all laser units are without temperature control. This means that the system can tolerate wavelength drift of the laser when ambient temperature changes.

4. In claim 1, the wavelength coverage for the entire band is from 1300 to 1700 nm. Each laser in claim 2 has a unique wavelength in this range and the space for any two adjacent channels is 6 nm.

5. Channel multiplex device in claim 1 has the same construct as de-multiplex device. But the light traveling direction is reverse:

6. The channel de-/multiplexing device in claim 5 comprise:
The first stage is a plurality of CWDM, each of them to collect/extract between a plurality of individual channels and a small sub-group of the entire band in claim 1;
The second stage is another CWDM, collecting/extracting between a plurality of small bands from the first stage CWDM and the trunk port;
A plurality of semiconductor laser amplifiers in each path of the small optical path between the first and the second stage CWDM.

7. Semiconductor laser amplifier in claim 6 is the conventional semiconductor F-P laser with anti-reflection coating on both two ends.

8. The band and bandwidth of each semiconductor laser amplifier in claim 6 is optimized and selected such that each amplifier for its small band covers the amplification for this small band.
